(19) United States
(12) Patent Application Publication
(10) Pub. No.: US 2026/0358812 A1
(43) Pub. Date: Nov. 12, 2026

(54) INFORMATION PROCESSING METHOD, INFORMATION PROCESSING DEVICE, AND PROGRAM

(71) Applicant: SONY GROUP CORPORATION, TOKYO (JP)

(72) Inventor: MASAKI WAKABAYASHI, TOKYO (JP)

(21) Appl. No.: 19/131,970

(22) PCT Filed: Nov. 14, 2023
(86) PCT No.: PCT/JP2023/040869

§ 371 Date: May 22, 2025

(30) Foreign Application Priority Data
Nov. 30, 2022 (JP) 2022-191924

(51) Int. Cl. G05D 1/622

(52) U.S. Cl. CPC G05D 1/622

(57) ABSTRACT

The present disclosure relates to an information processing method, an information processing device, and a program capable of reducing an amount of calculation required for avoiding an obstacle. A plurality of free space line segments is set between a self-position of a mobile body and obstacle information around the mobile body obtained on the basis of sensor data, and in a case where a line segment group including the free space line segments satisfies a predetermined division condition, division of the line segment group is performed until the division condition is no longer satisfied, and a set of clusters in which the line segment group obtained by the division is set as one cluster is output as free space information. The present disclosure can be applied to the mobile body that performs autonomous movement.

### TECHNICAL FIELD

The present disclosure relates to an information processing method, an information processing device, and a program, and particularly relates to an information processing method, an information processing device, and a program capable of reducing an amount of calculation required for avoiding an obstacle.

### BACKGROUND ART

Conventionally, there is known a technology of recognizing an object around an autonomous mobile robot by clustering a point cloud obtained by a distance measurement sensor or the like.

For example, Patent Document 1 discloses an information processing device capable of shortening a processing time by hierarchically dividing an entire point cloud and treating point clouds that no longer satisfy a division condition as clusters as they are.

### CITATION LIST

### Patent Document

Patent Document 1: Japanese Patent Application Laid-Open No. 2021-99689

### SUMMARY OF THE INVENTION

### Problems to be Solved by the Invention

Conventionally, in a case where an autonomous mobile robot is moved while avoiding an obstacle, a large amount of calculation has been required to obtain a safe movable range on the basis of obstacle information. This hinders higher agility, downsizing, and long-time movement of the autonomous mobile robot.

The present disclosure is achieved in view of such a situation, and aims to reduce an amount of calculation required for avoiding an obstacle.

### Solutions to Problems

An information processing method of the present disclosure is an information processing method including: setting a plurality of free space line segments between a self-position of a mobile body and obstacle information around the mobile body obtained on the basis of sensor data; performing, in a case where a line segment group including the free space line segments satisfies a predetermined division condition, division of the line segment group until the division condition is no longer satisfied; and outputting a set of clusters in which the line segment group obtained by the division is set as one cluster as free space information.

An information processing device of the present disclosure is an information processing device including: a setting unit that sets a plurality of free space line segments between a self-position of a mobile body and obstacle information around the mobile body obtained on the basis of sensor data; a division processing unit that performs, in a case where a line segment group including the free space line segments satisfies a predetermined division condition, division of the line segment group until the division condition is no longer satisfied; and an output unit that outputs a set of clusters in which the line segment group obtained by the division is set as one cluster as free space information.

A program of the present disclosure is a program for causing a computer to execute processing including: setting a plurality of free space line segments between a self-position of a mobile body and obstacle information around the mobile body obtained on the basis of sensor data; performing, in a case where a line segment group including the free space line segments satisfies a predetermined division condition, division of the line segment group until the division condition is no longer satisfied; and outputting a set of clusters in which the line segment group obtained by the division is set as one cluster as free space information.

In the present disclosure, a plurality of free space line segments is set between a self-position of a mobile body and obstacle information around the mobile body obtained on the basis of sensor data, and in a case where a line segment group including the free space line segments satisfies a predetermined division condition, division of the line segment group is performed until the division condition is no longer satisfied, and a set of clusters in which the line segment group obtained by the division is set as one cluster is output as free space information.

### BRIEF DESCRIPTION OF DRAWINGS

FIG. 1 is a diagram illustrating an example of a method of obtaining a free space by a conventional technology.

FIG. 2 is a diagram illustrating an outline of a method of obtaining a free space by a technology according to the present disclosure.

FIG. 3 is a block diagram illustrating a configuration example of a mobile body according to an embodiment of the present disclosure.

FIG. 4 is a block diagram illustrating a functional configuration example of a free space information generation unit.

FIG. 5 is a flowchart for describing a flow of free space information generation processing.

FIG. 6 is a diagram for describing setting of free space line segments.

FIG. 7 is a diagram for describing setting of out-of-region line segments.

FIG. 8 is a diagram illustrating an outline of hierarchy division processing of a cluster.

FIG. 9 is a flowchart for describing details of the hierarchy division processing.

FIG. 10 is a diagram illustrating an example of a flow of hierarchy division of the cluster.

FIG. 11 is a diagram illustrating an example of the flow of the hierarchy division of the cluster.

FIG. 12 is a diagram for describing conversion of a set of the clusters into ellipsoid expression.

FIG. 13 is a diagram illustrating a relationship between an obstacle ellipsoid and a free space ellipsoid.

FIG. 14 is a diagram illustrating a flow of conversion of the set of clusters into voxel expression.

FIG. 15 is a block diagram illustrating another configuration example of the mobile body.

FIG. 16 is a block diagram illustrating another configuration example of the mobile body.

FIG. 17 is a block diagram illustrating another configuration example of the mobile body.

FIG. 18 is a block diagram illustrating another configuration example of the mobile body.

FIG. 19 is a block diagram illustrating a configuration example of hardware of a computer.

### MODE FOR CARRYING OUT THE INVENTION

Hereinafter, a mode for carrying out the present disclosure (hereinafter referred to as an embodiment) will be described. Note that the description will be given in the following order.

1. Problems of Conventional Technology and Outline of Technology According to Present Disclosure

2. Configuration Example of Mobile Body to which Technology According to Present Disclosure is Applied

3. Functional Configuration Example of Free Space Information Generation Unit

4. Flow of Free Space Information Generation Processing

5. Details of Hierarchy Division Processing

6. Conversion of Output Format of Cluster Group

7. Another Configuration Example of Mobile Body

8. Configuration Example of Hardware of Computer

### 1. Problems of Conventional Technology and Outline of Technology According to Present Disclosure

Conventionally, in a case where an autonomous mobile robot is moved while avoiding an obstacle, a large amount of calculation has been required to obtain a safe movable range (hereinafter referred to as a free space, or the like) on the basis of obstacle information.

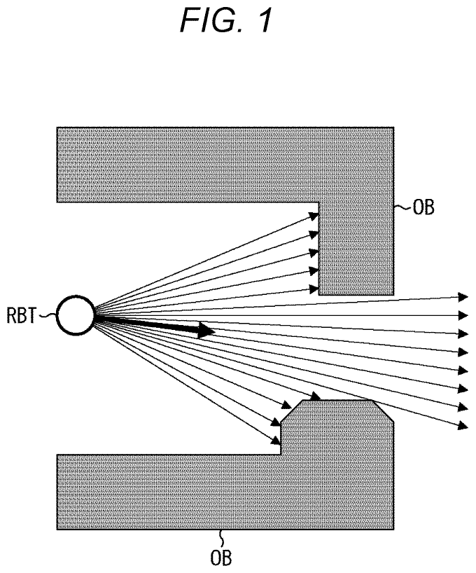

Specifically, as illustrated in FIG. 1, a robot RBT sets lines of sight (light beams) between a self-position and an obstacle OB by a ray casting method. The set number of light beams is a value corresponding to the number of voxels corresponding to the obstacle OB included in a field of view from the robot RBT. Then, the robot RBT arranges points for each pitch width of the voxel on the set light beams, and obtains a free space from an entire set of the points. At this time, since each point is arranged in proportion to a cube of the pitch width of the voxel for each of vertical, horizontal, and depth directions based on the self-position of the robot RBT, an amount of calculation therefor becomes enormous.

In this manner, the large amount of calculation required to obtain the free space has hindered higher agility, downsizing, and long-time movement of the autonomous mobile robot.

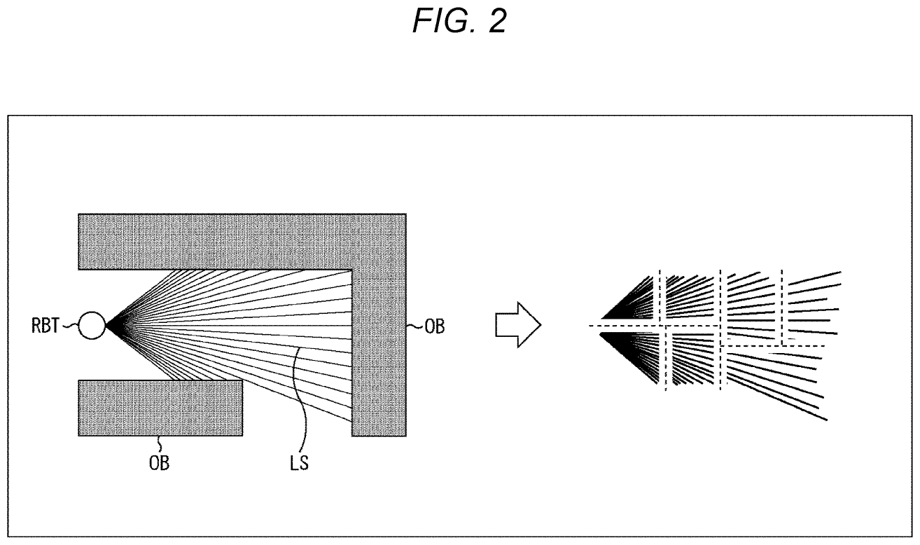

Therefore, in the technology according to the present disclosure, first, as illustrated on a left side of FIG. 2, line segments LS representing lines of sight are set between a robot RBT and an obstacle OB. Then, as illustrated on a right side of FIG. 2, an entire set line segment group is hierarchically divided, and a set in which line segment groups that no longer satisfy a division condition are used as they are as clusters (cluster group) is set as free space information representing a free space.

According to the technology according to the present disclosure, it is possible to treat the lines of sight from the robot RBT as the line segments without replacing the lines of sight with points. Therefore, it is possible to reduce an amount of calculation required for avoiding the obstacle, and eventually, it is possible to implement higher agility, downsizing, and long-time movement of the autonomous mobile robot.

### 2. Configuration Example of Mobile Body to which Technology According to Present Disclosure is Applied

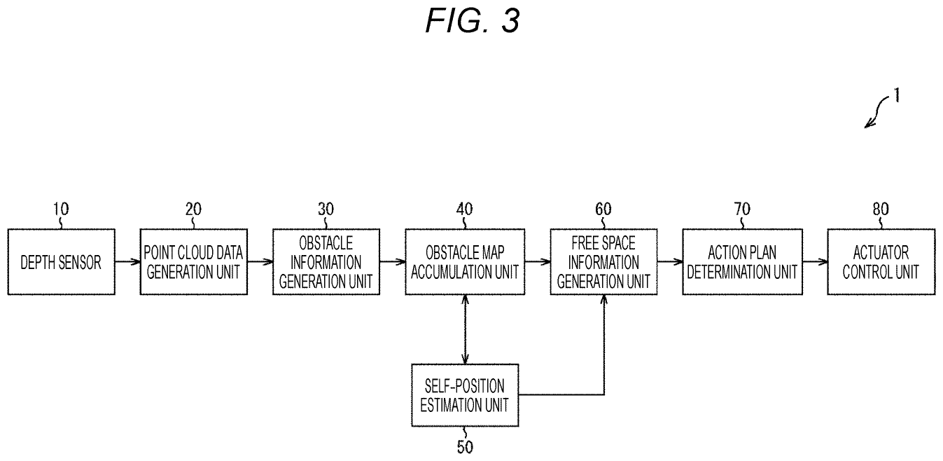

FIG. 3 is a block diagram illustrating a configuration example of a mobile body 1 according to an embodiment of the present disclosure.

A mobile body 1 is configured to generate map data on the basis of an image obtained by imaging around the mobile body 1, and perform autonomous movement using the map data. For example, the mobile body 1 may be a traveling robot that is autonomously movable and travels on a plane, or may be a drone that flies in a space.

The mobile body 1 includes a depth sensor 10, a point cloud data generation unit 20, an obstacle information generation unit 30, an obstacle map accumulation unit 40, a self-position estimation unit 50, a free space information generation unit 60, an action plan determination unit 70, and an actuator control unit 80.

The depth sensor 10 can include an imaging unit that acquires an image of an environment around the mobile body 1, such as a stereo camera, a monocular camera, a color camera, an infrared camera, a spectral camera, or a polarization camera. The depth sensor 10 estimates a depth of a subject included in the image, and supplies sensor data regarding the estimated depth to the point cloud data generation unit 20.

The depth sensor 10 may include a distance measurement sensor that measures a distance to an object, such as an ultrasonic sensor, a time of flight (ToF) sensor, radio detecting and ranging (RADAR), or light detection and ranging (LiDAR). In this case, the depth sensor 10 supplies, to the point cloud data generation unit 20, acquired sensor data regarding a distance and orientation to a measurement point.

The depth sensor 10 may be provided in another device, object, or the like outside the mobile body 1 as long as it can sense the environment around the mobile body 1. For example, the depth sensor 10 may be provided on a ceiling, a wall, a floor, or the like of a space where the mobile body 1 exists.

The point cloud data generation unit 20 generates point cloud data representing an object in a three-dimensional space on the basis of sensor data from the depth sensor 10, and supplies the point cloud data to the obstacle information generation unit 30.

The obstacle information generation unit 30 generates obstacle information representing an obstacle existing around the mobile body 1 on the basis of point cloud data from the point cloud data generation unit 20.

For example, the obstacle information generation unit 30 clusters a point cloud included in the point cloud data from the point cloud data generation unit 20 to generate a cluster group including a plurality of clusters. The generated cluster group corresponds to a minute plane group constituting an object surface existing around the mobile body 1.

Each of the clusters can be expressed by, for example, a flat ellipsoid based on center coordinates of the cluster and a probability distribution shape. Specifically, the cluster can be expressed by a flat ellipsoid that is centered on an average value of coordinates of points included in the cluster and that has covariance of the coordinates of the points included in the cluster as a thickness. In such a cluster as the flat ellipsoid, a vector indicating a normal direction with respect to a flat surface and the thickness in the normal direction of the flat ellipsoid is a representative parameter of the shape.

Specifically, the obstacle information generation unit 30 divides the point cloud included in the point cloud data into a plurality of partial point clouds until a division condition is no longer satisfied. Then, the obstacle information generation unit 30 clusters each of the partial point clouds satisfying a predetermined clustering condition to generate the cluster group corresponding to the minute plane group constituting the object surface. As each of the predetermined division condition and the predetermined clustering condition, an optimal condition can be appropriately set on the basis of characteristics of the point cloud and the like.

In this manner, since the clustering is performed on each of the point clouds after the division until the predetermined division condition is no longer satisfied, a size of each of the point clouds as objects of the clustering can be reduced, and a processing time of the clustering can be further shortened. Furthermore, since a point cloud that does not satisfy the predetermined clustering condition and is highly likely to be inaccurate can be excluded from the objects of the clustering, accuracy of the clustering can be further improved.

Then, the obstacle information generation unit 30 recognizes the obstacle by grouping one or a plurality of clusters on the basis of the cluster group generated as the obstacle information. The obstacle corresponds to each object around the mobile body 1, and is specifically a person, a wall, a floor, or the like around the mobile body 1.

The obstacle map accumulation unit 40 generates and accumulates map data on the basis of obstacle information generated by the obstacle information generation unit 30 and self-position data generated by the self-position estimation unit 50. The map data including the obstacle information is supplied to the self-position estimation unit 50 and the free space information generation unit 60.

The map data is three-dimensional data, and is expressed by, for example, a plurality of clusters (flat ellipsoids) expressed using center coordinates and a probability distribution shape. With this arrangement, as compared with, for example, a case where the map data is configured using a so-called grid map, the map data can have a suppressed data size and improved accuracy. Since the mobile body 1 can operate on the basis of such map data expressed by the plurality of clusters, the mobile body 1 can perform processing in a short time using fewer operation resources.

The self-position estimation unit 50 estimates a position of the mobile body 1 on the basis of map data from the obstacle map accumulation unit 40 and measurement information from an inertial measurement unit (IMU) (not illustrated) included in the mobile body 1, and generates self-position data indicating the position of the mobile body 1. In a case where the mobile body 1 is a traveling robot that travels on a plane, the self-position data may be generated by odometry using a rotation angle of a wheel. The generated self-position data is supplied to the obstacle map accumulation unit 40 and the free space information generation unit 60.

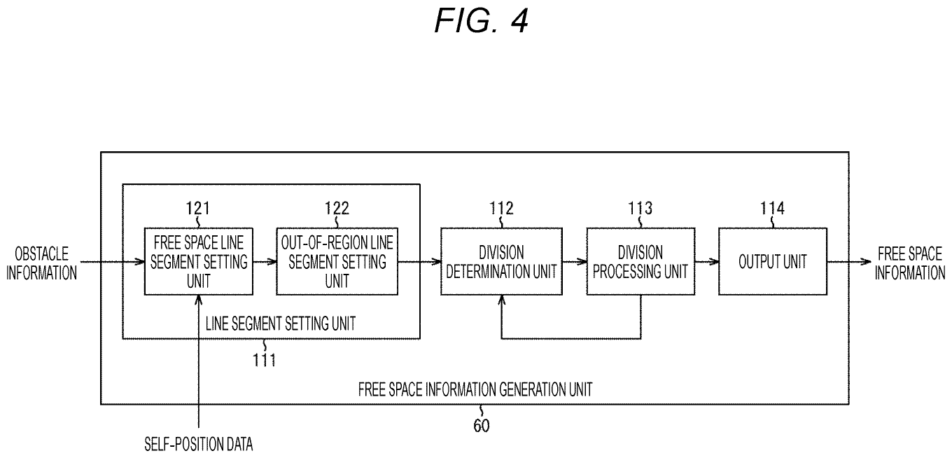

The free space information generation unit 60 generates free space information representing a free space (a range in which the mobile body 1 is safely movable) on the basis of self-position data from the self-position estimation unit 50 and map data (obstacle information) from the obstacle map accumulation unit 40, and supplies the free space information to the action plan determination unit 70. A detailed configuration of the free space information generation unit 60 will be described later with reference to FIG. 4.

The action plan determination unit 70 determines an action plan of the mobile body 1 by grasping a situation around the mobile body 1 on the basis of free space information from the free space information generation unit 60. The determined action plan is supplied to the actuator control unit 80.

The actuator control unit 80 controls one or a plurality of motors on the basis of an action plan determined by the action plan determination unit 70. A movement mechanism (not illustrated) is driven on the basis of power generated by the motor, so that the mobile body 1 can move. In a case where the mobile body 1 is a traveling robot that travels on a plane, for example, the movement mechanism includes one or a plurality of wheels, and in a case where the mobile body 1 is a drone, for example, the movement mechanism includes one or a plurality of propellers.

Note that, among the functional blocks constituting the mobile body 1, at least any one of the point cloud data generation unit 20 to the action plan determination unit 70 may be provided outside the mobile body 1. For example, these functional blocks can be provided in a controller (proportional controller) capable of directly communicating with the mobile body 1, a server capable of communicating via a network, or the like.

### 3. Functional Configuration Example of Free Space Information Generation Unit

With reference to FIG. 4, a functional configuration example of the free space information generation unit 60 will be described.

As illustrated in FIG. 4, the free space information generation unit 60 includes a line segment setting unit 111, a division determination unit 112, a division processing unit 113, and an output unit 114.

The line segment setting unit 111 sets line segments representing lines of sight between the mobile body 1 and an obstacle on the basis of self-position data from the self-position estimation unit 50 and map data (obstacle information) from the obstacle map accumulation unit 40. The line segment setting unit 111 includes a free space line segment setting unit 121 and an out-of-region line segment setting unit 122.

The free space line segment setting unit 121 sets a plurality of free space line segments between a self-position of the mobile body 1 and obstacle information around the mobile body 1. The free space line segments correspond to light beams representing lines of sight in the ray casting method. Note that the self-position of the mobile body 1 herein is only required to be a position of the mobile body 1 itself, such as a position of a center of gravity or a position of a distal end portion in a traveling direction of the mobile body 1. Furthermore, the self-position of the mobile body 1 may be a position of a sensor (including the depth sensor 10) provided in the mobile body 1, or may be a specific relative position based on the sensor provided in the mobile body 1. The specific relative position is set to be, for example, a center position or the like of two cameras constituting a stereo camera in a case where the sensor is constituted by the stereo camera.

The out-of-region line segment setting unit 122 further sets out-of-region line segments for a region not included in a field of view from the mobile body 1 in a bounding box surrounding the free space line segments set by the free space line segment setting unit 121.

The free space line segments and the out-of-region line segments set by the line segment setting unit 111 are supplied to the division determination unit 112.

The division determination unit 112 determines whether or not a line segment group including free space line segments and out-of-region line segments satisfies a predetermined division condition.

It is assumed that the division condition includes, for example, one or more of a condition for the number of free space line segments included in a bounding box, a condition for presence or absence of the out-of-region line segment in the bounding box, and a condition for a size of the bounding box.

The division processing unit 113 divides, in a case where the division determination unit 112 determines that a line segment group satisfies a division condition, the line segment group. Then, the division determination unit 112 newly sets bounding boxes for the line segment groups obtained by the division to determine whether or not the line segment groups obtained by the division satisfy the division condition.

That is, in a case where the line segment group satisfies the division condition, the division processing unit 113 divides the line segment group until the division condition is no longer satisfied.

The output unit 114 outputs, as free space information, a set of clusters in which a line segment group obtained by division is set as one cluster. At this time, the output unit 114 can convert an output format of the set of clusters which includes the line segment groups and is output as the free space information into another output format, and output the set of clusters.

### 4. Flow of Free Space Information Generation Processing

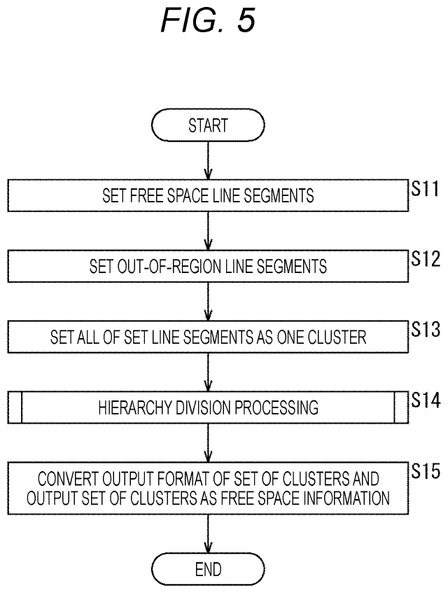

Next, a flow of free space information generation processing by the free space information generation unit 60 of FIG. 4 will be described with reference to a flowchart of FIG. 5. The processing of FIG. 5 can be executed each time obstacle information is generated on the basis of point cloud data and map data is updated.

In step S11, the free space line segment setting unit 121 of the line segment setting unit 111 sets a plurality of free space line segments between a self-position of the mobile body 1 and obstacle information around the mobile body 1.

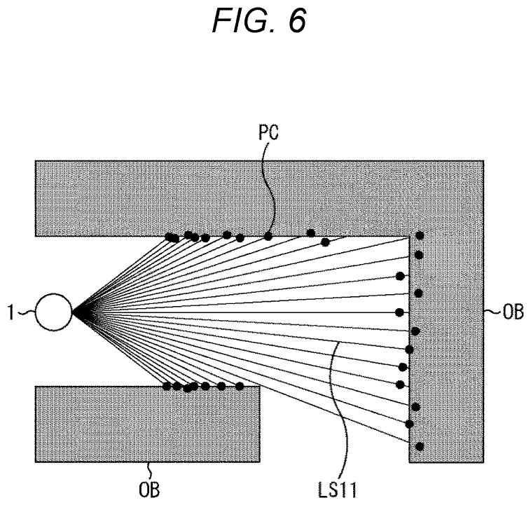

For example, as illustrated in FIG. 6, in a case where a point cloud PC representing the obstacle OB is obtained as the obstacle information, the free space line segment setting unit 121 sets free space line segments LS11 between the self-position of the mobile body 1 and each of the point cloud PC. The free space line segments LS11 are radially set toward each of the point cloud PC in a conical surface having the self-position of the mobile body 1 as a vertex. A space in which the free space line segments LS11 are set can be said to be a region through which lines of sight from the mobile body 1 pass.

Note that, as illustrated in FIG. 6, the point cloud PC does not necessarily match a surface of the obstacle OB due to variations in accuracy of the depth sensor 10, or the like.

In step S12, the out-of-region line segment setting unit 122 of the line segment setting unit 111 sets a bounding box surrounding the free space line segments set by the free space line segment setting unit 121, and further sets out-of-region line segments for a region not included in a field of view from the mobile body 1 (a region through which the lines of sight do not pass).

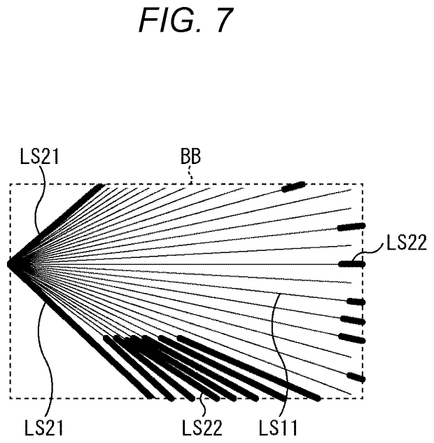

For example, as illustrated in FIG. 7, the out-of-region line segment setting unit 122 first sets a bounding box BB surrounding all the free space line segments LS11 set by the free space line segment setting unit 121.

Next, in the bounding box BB, the out-of-region line segment setting unit 122 sets out-of-region line segments LS21 indicated by thick lines in the drawing on a boundary surface (that is, the conical surface described above) of the field of view from the mobile body 1. Moreover, in the bounding box BB, the out-of-region line segment setting unit 122 sets out-of-region line segments LS22 indicated by thick lines in the drawing on extension lines of the free space line segments LS11 that have not reached the bounding box BB.

In step S13, the line segment setting unit 111 sets, as one cluster, a line segment group including all the free space line segments and the out-of-region line segments as described with reference to FIG. 7.

In step S14, the division determination unit 112 and the division processing unit 113 execute hierarchy division processing of hierarchically dividing the line segment group as the cluster.

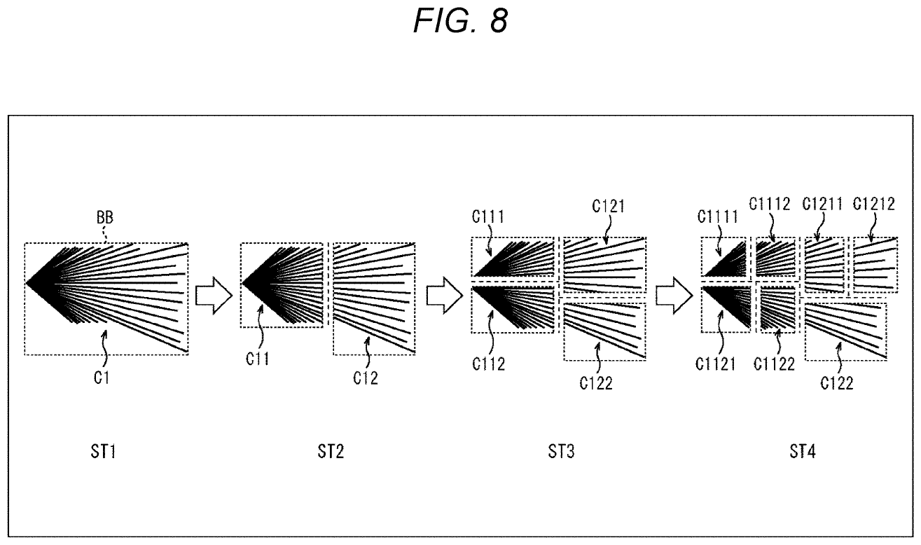

FIG. 8 is a diagram illustrating an outline of the hierarchy division processing of the cluster. Note that the cluster herein is not a set of line segments grouped on the basis of similarity, but simply refers to a line segment group including a set of a plurality of line segments, and each of line segment groups obtained by division is also referred to as the cluster.

In a state ST1, the bounding box BB surrounding the line segment group including all the free space line segments is illustrated as one cluster C1.

In a case where the cluster C1 in the state ST1 satisfies a division condition, the cluster C1 is divided into a cluster C11 and a cluster C12 (state ST2).

In a case where each of the cluster C11 and the cluster C12 in the state ST2 satisfies the division condition, the cluster C11 is divided into a cluster C111 and a cluster C112, and the cluster C12 is divided into a cluster C121 and a cluster C122 (state ST3).

In a case where each of the cluster C111 and the cluster C112 in the state ST3 satisfies the division condition, the cluster C111 is divided into a cluster C1111 and a cluster C1112, and the cluster C112 is divided into a cluster C1121 and a cluster C1122 (state ST4).

Furthermore, in a case where the cluster C121 in the state ST3 satisfies the division condition while the cluster C122 does not satisfy the division condition, the cluster C121 is divided into a cluster C1211 and a cluster C1212, and the cluster C122 is not further divided.

In this manner, the hierarchy division processing is executed until all the line segment groups (clusters) obtained by the division no longer satisfy the division condition. Details of the hierarchy division processing will be described later.

Then, in step S15, the output unit 114 converts an output format of a set of clusters in which each of the line segment groups obtained by the division is set as one cluster as necessary, and outputs the set of the clusters as free space information.

### 5. Details of Hierarchy Division Processing

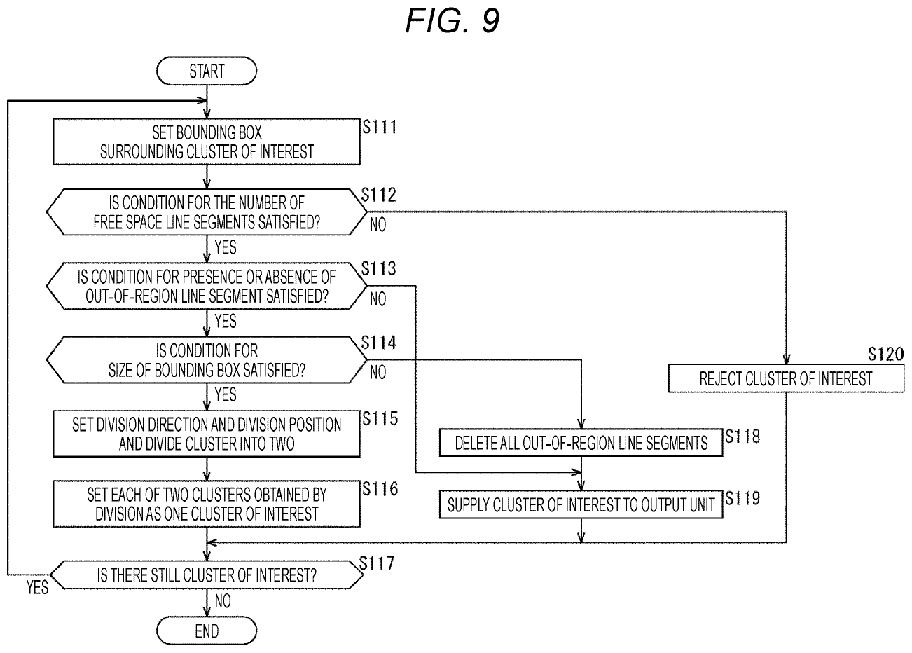

FIG. 9 is a flowchart for describing the details of the hierarchy division processing executed in step S14 of the free space information generation processing described above. Hereinafter, a cluster including a line segment group to be determined for division is referred to as a cluster of interest.

In step S111, the division determination unit 112 sets a bounding box (minimum rectangular parallelepiped) surrounding the cluster of interest (line segment group). The bounding box is set in a three-dimensional coordinate space indicated by three axes of an x axis, a y axis, and a z axis. Here, in a case where the line segment group including all the free space line segments and the out-of-region line segments is the cluster of interest, that is, in an initial state, step S111 is skipped.

In step S112, the division determination unit 112 determines whether or not the cluster of interest satisfies a condition for the number of free space line segments. For example, the division determination unit 112 determines whether or not the number of free space line segments included in the bounding box is a predetermined number or more.

In a case where it is determined in step S112 that the cluster of interest satisfies the condition for the number of free space line segments, that is, in a case where the number of free space line segments included in the bounding box is the predetermined number or more, the processing proceeds to step S113.

In step S113, the division determination unit 112 determines whether or not the cluster of interest satisfies a condition for presence or absence of the out-of-region line segment. For example, the division determination unit 112 determines whether or not the out-of-region line segment exists in the bounding box.

In a case where it is determined in step S113 that the cluster of interest satisfies the condition for the presence or absence of the out-of-region line segment, that is, in a case where the out-of-region line segment exists in the bounding box, the processing proceeds to step S114.

In step S114, the division determination unit 112 determines whether or not the cluster of interest satisfies a condition for a size of the bounding box. For example, it is determined whether or not a maximum length of the bounding box exceeds a predetermined value.

In a case where it is determined in step S114 that the cluster of interest satisfies the condition for the size of the bounding box, that is, in a case where the maximum length of the bounding box exceeds the predetermined value, the processing proceeds to step S115.

In step S115, the division processing unit 113 sets a division direction and a division position for the bounding box of the cluster of interest on the basis of an axial direction in which a length of the bounding box is the longest among the respective axial directions of the x axis, the y axis, and the z axis, and divides the cluster into two. For example, the direction in which the length of the bounding box is the longest is set as the division direction, and a center position of the bounding box in the division direction is set as the division position.

In step S116, the division determination unit 112 sets each of the two clusters (line segment groups) obtained by the division as the cluster of interest.

Thereafter, in step S117, the division determination unit 112 determines whether or not there is still a cluster of interest. Here, it is determined that there is still a cluster of interest until all the clusters of interest are supplied to the output unit 114 or rejected.

In a case where it is determined in step S117 that there is still a cluster of interest, the processing returns to step S111, and the processing in step S111 and subsequent steps is repeated for each of the clusters of interest obtained by the division.

Meanwhile, in a case where it is determined in step S114 that the cluster of interest does not satisfy the condition for the size of the bounding box, that is, in a case where the maximum length of the bounding box does not exceed the predetermined value, the processing proceeds to step S118.

In step S118, the division processing unit 113 deletes the out-of-region line segments included in the cluster of interest (line segment group for which the bounding box is set).

Then, in step S119, the division processing unit 113 supplies the cluster of interest from which the out-of-region line segments have been deleted to the output unit 114. That is, in a case where the size of the cluster (bounding box) is reduced to a certain extent by the division, the cluster becomes an object to be output by the deletion of the included out-of-region line segments. Note that the condition (predetermined value) for the size of the bounding box can be set according to to what extent the size of the cluster is to be reduced.

On the other hand, in a case where it is determined in step S113 that the cluster of interest does not satisfy the condition for the presence or absence of the out-of-region line segment, that is, in a case where the out-of-region line segment does not exist in the bounding box, step S118 is skipped and the processing proceeds to step S119.

In this case, in step S119, the division processing unit 113 supplies the cluster of interest that does not include the out-of-region line segment to the output unit 114. That is, in a case where the out-of-region line segment included in the cluster (bounding box) does not exist due to the division, the cluster becomes the object to be output.

Meanwhile, in a case where it is determined in step S112 that the cluster of interest does not satisfy the condition for the number of free space line segments, that is, in a case where the number of free space line segments included in the bounding box does not exceed the predetermined number, the processing proceeds to step S120.

In step S120, the division processing unit 113 rejects the cluster of interest in which the number of free space line segments does not exceed the predetermined number. That is, in a case where the number of free space line segments included in the cluster (bounding box) becomes less than the predetermined number due to the division, the cluster is excluded from the object to be output. Note that the condition (predetermined number) for the number of free space line segments can be set according to to what extent a cluster with sparse line segment density is set as the object to be output.

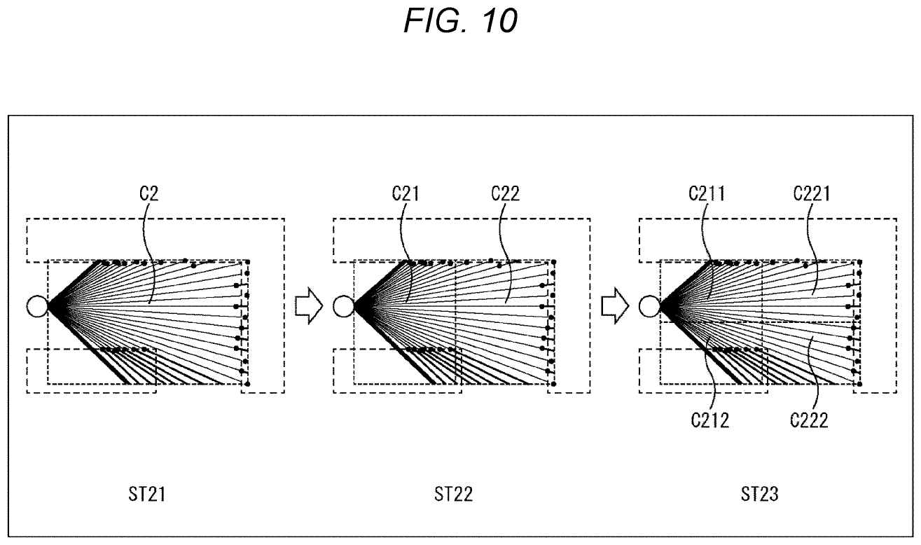

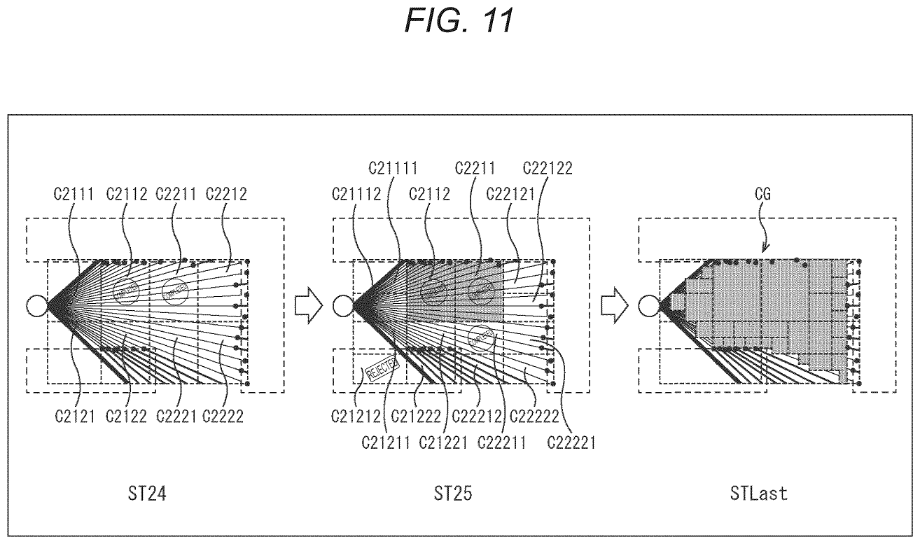

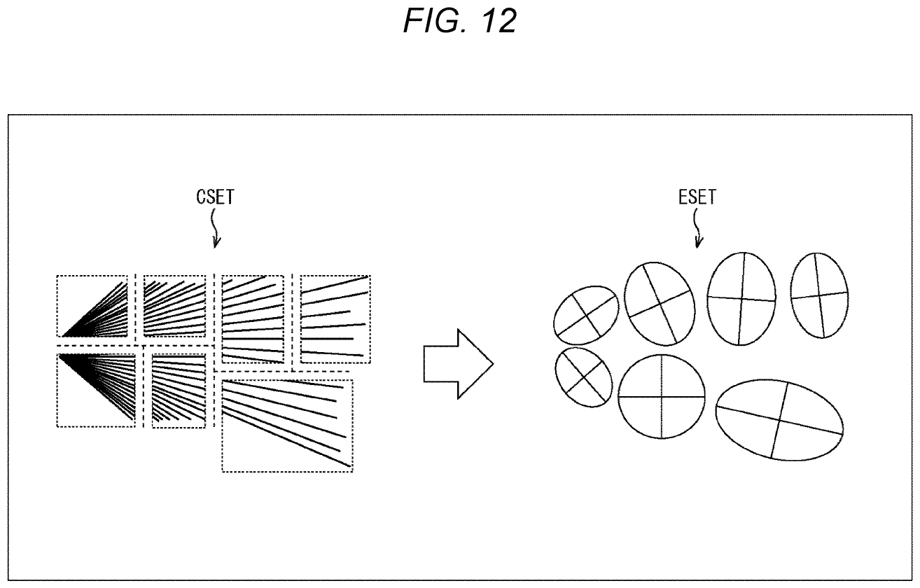

Here, an example of a flow of the hierarchy division of the cluster will be described with reference to FIGS. 10 and 11.

In a state ST21, as the initial state, the line segment group including all the free space line segments (thin lines) and the out-of-region line segments (thick lines) is illustrated as one cluster C2.

In a case where the cluster C2 in the state ST21 satisfies all the division conditions, the cluster C2 is divided into a cluster C21 and a cluster C22 (state ST22).

In a case where each of the cluster C21 and the cluster C22 in the state ST22 satisfies all the division conditions, the cluster C21 is divided into a cluster C211 and a cluster C212, and the cluster C22 is divided into a cluster C221 and a cluster C222 (state ST23).

In the state ST23, any one of the clusters obtained by the division includes the out-of-region line segment.

In a case where each of the cluster C211 and the cluster C212 in the state ST23 satisfies all the division conditions, the cluster C211 is divided into a cluster C2111 and a cluster C2112, and the cluster C212 is divided into a cluster C2121 and a cluster C2122 (state ST24 of FIG. 11).

Similarly, in a case where each of the cluster C221 and the cluster C222 in the state ST23 satisfies all the division conditions, the cluster C221 is divided into a cluster C2211 and a cluster C2212, and the cluster C222 is divided into a cluster C2221 and a cluster C2222 (state ST24 of FIG. 11).

At this time, in the state ST24, among the clusters obtained by the division, the cluster C2112 and the cluster C2211 do not include the out-of-region line segment. That is, the cluster C2112 and the cluster C2211 become the objects to be output without being further divided.

Although description of all the clusters in the state ST24 is omitted, in a case where the cluster C2121 among the clusters in the state ST24 satisfies all the division conditions, the cluster C2121 is divided into a cluster C21211 and a cluster C21212 (state ST25).

Furthermore, in a case where the cluster C2221 among the clusters in the state ST24 satisfies all the division conditions, the cluster C2221 is divided into a cluster C22211 and a cluster C22212 (state ST25).

At this time, in the state ST25, the number of free space line segments included in the cluster C21212 among the clusters obtained by the division is less than the predetermined number. That is, the cluster C21212 is rejected and excluded from the object to be output. On the other hand, the cluster C22211 does not include the out-of-region line segment. That is, the cluster C22211 becomes the object to be output without being further divided.

In this manner, by repeating the hierarchy division of the cluster, as indicated by a state STLast, a cluster group CG including the clusters (line segment groups) that no longer satisfy the division condition is output as the free space information.

According to the above processing, the line segment group including the free space line segment set between the self-position of the mobile body 1 and the obstacle information is hierarchically divided, and the cluster group in which the line segment groups that no longer satisfy the division condition are used as the clusters is output as the free space information representing the free space. That is, since it is possible to treat the lines of sight from the mobile body 1 as they are as the line segments without replacing the lines of sight with the points, it is possible to reduce the amount of calculation required for avoiding the obstacle, and eventually, it is possible to implement the higher agility, downsizing, and long-time movement of the autonomous mobile robot.

Note that the space represented by the finally output free space information should not be wider than the original safely movable range. In a case where the space represented by the free space information is wider than the originally safe movable range, there is a possibility that the mobile body 1 erroneously recognizes a portion where the obstacle can exist as the free space, and as a result, collides with the obstacle.

Therefore, in the technology according to the present disclosure, the out-of-region line segment is set in addition to the free space line segments, and as described with reference to FIGS. 10 and 11, the processing based on the presence or absence of the out-of-region line segment is performed in the hierarchy division of the cluster. With this arrangement, it is possible to prevent the space represented by the cluster group obtained by the hierarchy division from becoming wider than the original free space.

### 6. Conversion of Output Format of Cluster Group

As described above, the output unit 114 can convert the output format of the set of clusters which includes the line segment groups and is output as the free space information into another output format that is easy to treat, as necessary, and output the set of clusters.

(Conversion into Ellipsoid Expression)

The output unit 114 can convert the output format of the set of clusters including the line segment groups into ellipsoid expression based on an average and covariance of the line segment groups included in the clusters. The cluster including the line segment group can be expressed by an ellipsoid centered on an average value of the line segments included in the cluster and having covariance of the line segments included in the cluster as a thickness.

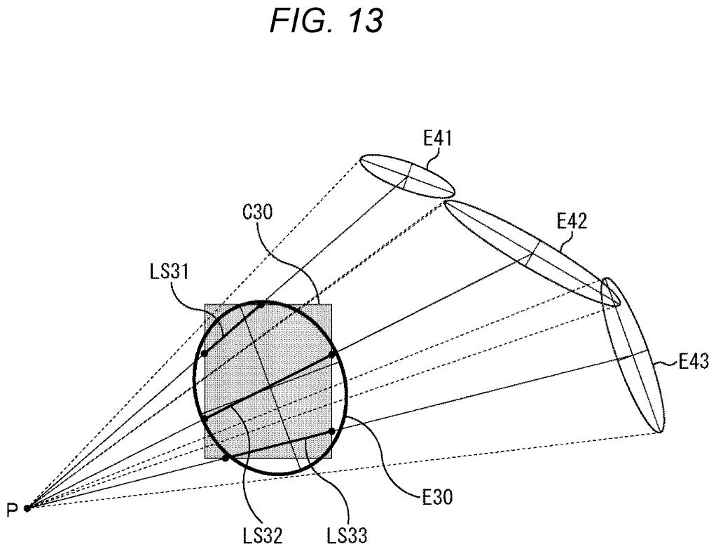

In this example, as illustrated in FIG. 12, the free space information is converted from a set of clusters CSET including a line segment group into a set of ellipsoids ESET, and the set of ellipsoids ESET is output. In this case, as described above, each cluster including the line segment group is converted with the obstacle information (obstacle ellipsoids) expressed by the flat ellipsoids as an input, whereby the free space information (free space ellipsoids) expressed by the ellipsoids is output.

Here, as illustrated in FIG. 13, a case where a certain one cluster C30 obtained by the hierarchy division is converted into a free space ellipsoid E30 expressed by an ellipsoid will be described as an example.

In the example of FIG. 13, the obstacle information is represented by three obstacle ellipsoids E41, E42, and E43. The cluster C30 includes partial line segments L31, L32, and L33 of three line segments set between a self-position P of the mobile body 1 and centers of the obstacle ellipsoids E41, E42, and E43, respectively.

In a case where a k-th obstacle ellipsoid (ωₖ, μₖ, Σₖ) is expressed by a weight ωₖ, a three-dimensional vector μₖ representing a center position, and a 3×3 covariance matrix Σₖ representing a shape, an i-th free space ellipsoid (ω′ᵢ, μ′ᵢ, Σ′ᵢ) can be expressed by a weight ω′ᵢ, a three-dimensional vector μ′₁ representing the center position, and a 3×3 covariance matrix Σ′ᵢ representing the shape.

Here, as individual coefficients for each of partial line segments ik (three in the example of FIG. 13) constituting the cluster, a coefficient fᵢₖ related to an end point on a side close to the self-position P, a coefficient tᵢₖ related to an end point on a side far from the self-position P, a coefficient rᵢₖ related to a length, a coefficient mix related to a middle point, and a unique coefficient cᵢₖ of the partial line segment are obtained.

The coefficients fᵢₖ and tᵢₖ can be obtained by the following expression.

$$[ Mathematical Expression 1 ]$$

$${f}_{ik} = \frac{Distance between “ end point on side close to self - position of line segment ik ” and “ self - position ”}{Distance between {µ}_{k} and “ self - position ”}$$

$${t}_{ik} = \frac{Distance between “ end point on side far from self - position of line segment ik ” and “ self - position ”}{Distance between {µ}_{k} and “ self - position ”}$$

The coefficients rᵢₖ, mᵢₖ, and cᵢₖ can be obtained by the following expression using the coefficients fᵢₖ and tᵢₖ obtained by the above expression.

$$[ Mathematical Expression 2 ]$$

$${r}_{ik} = {t}_{ik} - {f}_{ik} ,$$

$${m}_{ik} = \frac{1}{2} ( {f}_{ik} + {t}_{ik} ) ,$$

$${c}_{ik} = \frac{1}{3} ( {f}_{ik}^{2} + {f}_{ik} {t}_{ik} + {t}_{ik}^{2} )$$

By using the coefficients which are related to each of the line segments ik and are obtained as described above and the obstacle ellipsoid (ωₖ, μₖ, Σₖ), the free space ellipsoid (ω′ᵢ, μ′ᵢ, Σ′ᵢ) can be calculated by the following expression.

$${ω}_{i}^{′} = {\sum }_{k = 1}^{n} {r}_{ik} {ω}_{k} \qquad [ Mathematical Expression 3 ]$$

$${µ}_{i}^{′} = \frac{1}{{ω}_{i}^{′}} {\sum }_{k = 1}^{n} {r}_{ik} {m}_{ik} {ω}_{k} {µ}_{k}$$

$${\sum }_{i}^{′} = \frac{1}{{ω}_{i}^{′}} {\sum }_{k = 1}^{n} {r}_{ik} {c}_{ik} {ω}_{k} ( {\sum }_{k} + {µ}_{k} \cdot {µ}_{k}^{T} ) - {µ}_{i}^{′} \cdot {µ}_{k}^{′T}$$

As described above, the set of clusters including the line segment groups is output as the free space information in the ellipsoid expression.

(Conversion into Voxel Expression)

The output unit 114 can convert the output format of the set of clusters including the line segment groups into voxel expression in which the clusters are divided in units of voxels.

In this example, it is assumed that the obstacle information constituting the map data is expressed by voxels instead of the flat ellipsoids as described above. In this case, the obstacle information in the voxel expression is generated on the basis of the point cloud data from the point cloud data generation unit 20, and the map data in the voxel expression is generated, so that the free space information in the voxel expression is generated.

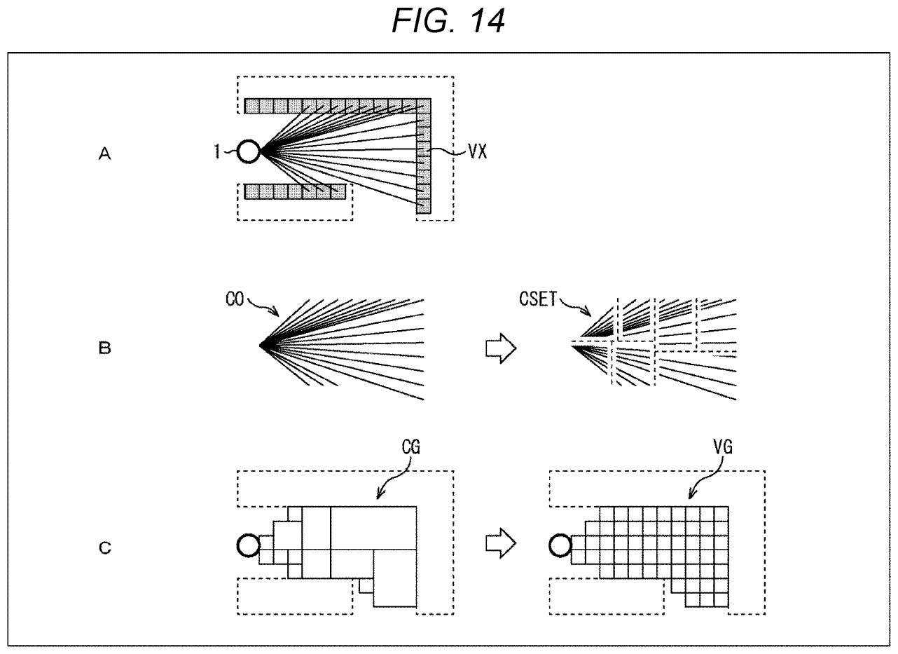

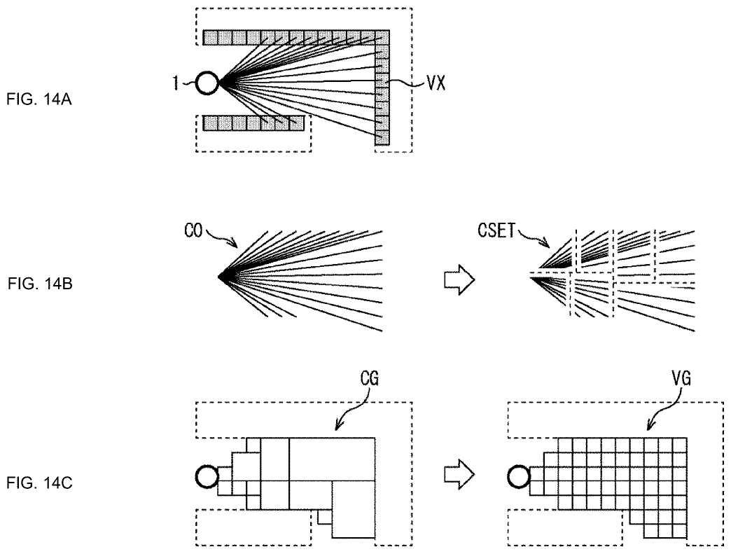

Here, a flow of the conversion of the cluster group into the voxel expression will be described with reference to FIG. 14.

First, as illustrated in A of FIG. 14, a plurality of free space line segments is set between the self-position of the mobile body 1 and obstacle information VX expressed by the voxels included in the field of view of the mobile body 1. At this time, for each line segment, first adjustment processing of deleting a portion exceeding a pitch width unit of the voxel at a far end far from the self-position is performed. Thereafter, out-of-region line segments are set, and a line segment group including all the free space line segments and the out-of-region line segments is set as one cluster C0, similarly to the free space information generation processing described above.

Next, as illustrated in B of FIG. 14, a set of clusters CSET including a plurality of line segment groups is obtained by hierarchically dividing the cluster C0, similarly to the hierarchy division processing described above. When the cluster is divided into two in hierarchy division processing here, second adjustment processing of making a division position match the pitch width unit of the voxel is performed.

Then, as illustrated in C of FIG. 14, a cluster group CG thus obtained is converted into a voxel group VG which is a set of the voxels. At this time, when the first adjustment processing and the second adjustment processing described above have been performed, all surfaces of the clusters constituting the cluster group CG are in a state of matching the pitch width unit of the voxel, and thus the conversion into the voxel group VG can be facilitated.

As described above, the set of clusters including the line segment groups is output as the free space information in the voxel expression.

### 7. Another Configuration Example of Mobile Body

### Another Configuration Example 1 of Mobile Body

The free space information generated in the mobile body may be used for the generation of the map data representing the free space.

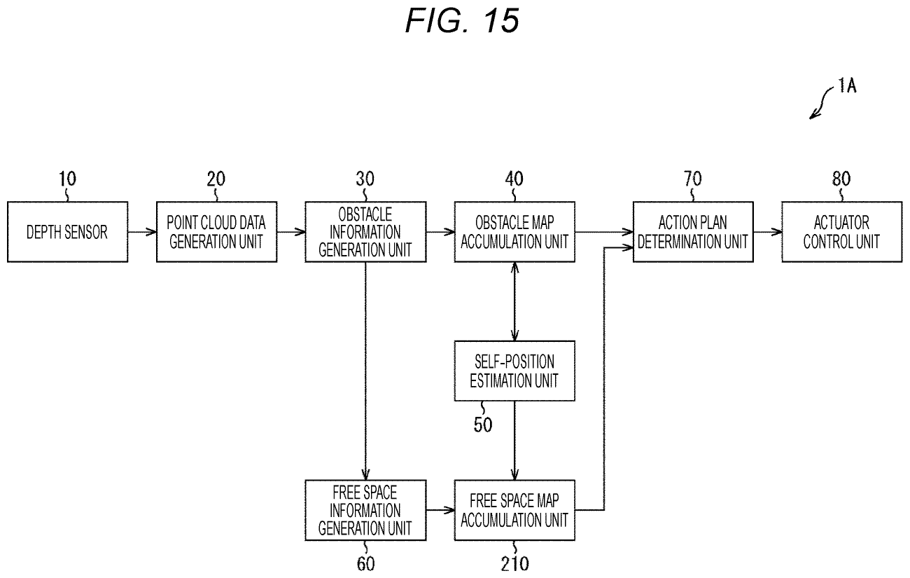

FIG. 15 is a block diagram illustrating a configuration example of a mobile body that generates map data representing a free space.

A mobile body 1A illustrated in FIG. 15 is different from the mobile body 1 illustrated in FIG. 1 in that a free space map accumulation unit 210 is newly provided.

Furthermore, in the mobile body 1A, the free space information generation unit 60 generates free space information on the basis of obstacle information from the obstacle information generation unit 30 instead of map data from the obstacle map accumulation unit 40, and supplies the free space information to the free space map accumulation unit 210.

The free space map accumulation unit 210 generates and accumulates map data representing a free space on the basis of self-position data from the self-position estimation unit 50 and the free space information generated by the free space information generation unit 60. Here, it is assumed that the map data generated by the free space map accumulation unit 210 is not used for estimation of a self-position by the self-position estimation unit 50.

The action plan determination unit 70 determines an action plan of the mobile body 1A on the basis of map data including the obstacle information accumulated in the obstacle map accumulation unit 40 and the map data including the free space information accumulated in the free space map accumulation unit 210.

According to the above configuration, since past free space information is stored by the free space map accumulation unit 210, it is possible to determine a situation and determine an action plan using free space information outside a current field of view.

### Another Configuration Example 2 of Mobile Body

Not only one depth sensor but also a plurality of depth sensors may be provided in the mobile body.

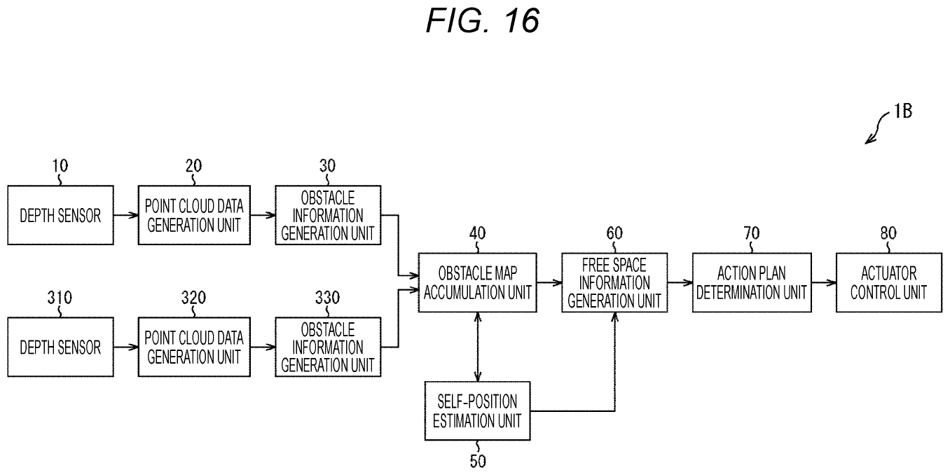

FIG. 16 is a block diagram illustrating a configuration example of a mobile body including a plurality of depth sensors.

A mobile body 1B illustrated in FIG. 16 is different from the mobile body 1 illustrated in FIG. 1 in that a depth sensor 310, a point cloud data generation unit 320, and an obstacle information generation unit 330 are newly provided. The depth sensor 310, the point cloud data generation unit 320, and the obstacle information generation unit 330 have functions similar to those of the depth sensor 10, the point cloud data generation unit 20, and the obstacle information generation unit 30, respectively.

Furthermore, in the mobile body 1B, the obstacle map accumulation unit 40 generates and accumulates map data using not only obstacle information generated by the obstacle information generation unit 30 but also obstacle information generated by the obstacle information generation unit 330.

According to the above configuration, for example, even in a case where accuracy of point cloud data generated on the basis of one depth sensor is low, complementation can be performed by point cloud data generated on the basis of the other depth sensor, so that accuracy of the obstacle information can be maintained as a whole. Furthermore, the configuration including the plurality of depth sensors can also be applied to a robot or the like that moves while sensing a plurality of directions such as front and back and left and right in a movement direction.

Note that, in the example of FIG. 16, it is assumed that the two depth sensors are provided, but three or more depth sensors may be provided.

### Another Configuration Example 3 of Mobile Body

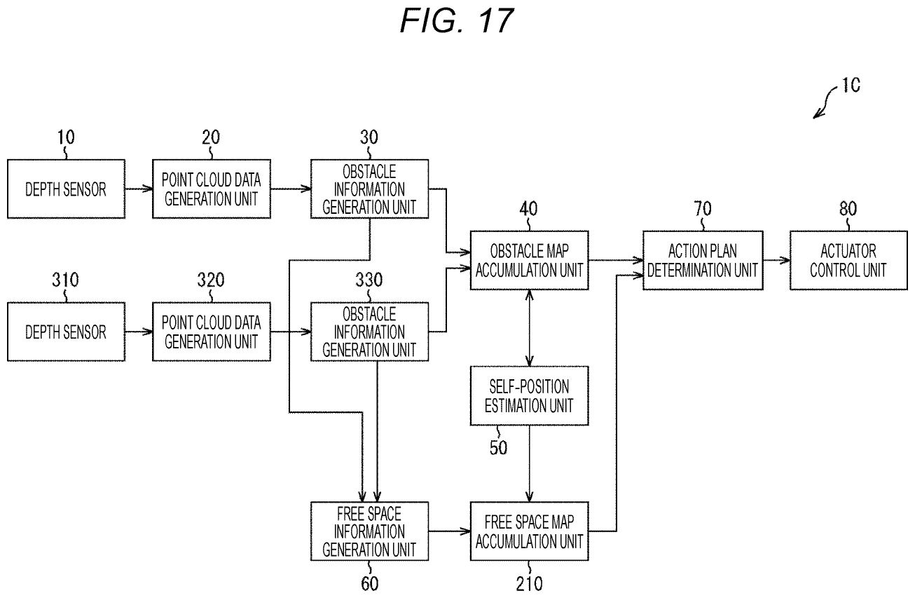

FIG. 17 is a block diagram illustrating a configuration example of a mobile body that includes a plurality of depth sensors and generates map data representing a free space.

A mobile body 1C illustrated in FIG. 17 is different from the mobile body 1A illustrated in FIG. 15 in that the depth sensor 310, the point cloud data generation unit 320, and the obstacle information generation unit 330 are newly provided.

According to the above configuration, it is possible to determine a situation and determine an action plan using free space information outside a current field of view while maintaining accuracy of obstacle information.

### Another Configuration Example 4 of Mobile Body

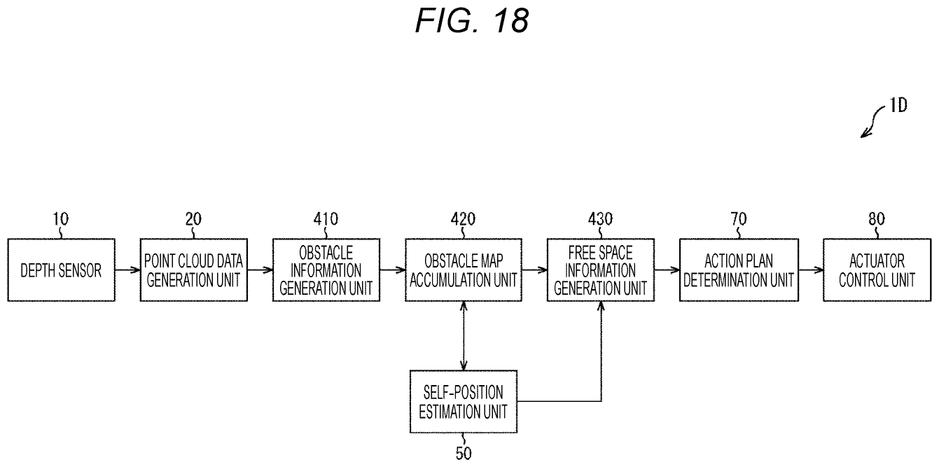

FIG. 18 is a block diagram illustrating a configuration example of a mobile body that outputs free space information in voxel expression.

A mobile body 1D illustrated in FIG. 18 is different from the mobile body 1 illustrated in FIG. 1 in that an obstacle information generation unit 410, an obstacle map accumulation unit 420, and a free space information generation unit 430 are provided instead of the obstacle information generation unit 30, the obstacle map accumulation unit 40, and the free space information generation unit 60, respectively.

In the mobile body 1D, the obstacle information generation unit 410 generates obstacle information in voxel expression on the basis of point cloud data from the point cloud data generation unit 20. The obstacle map accumulation unit 420 generates and accumulates map data in the voxel expression using the obstacle information in the voxel expression generated by the obstacle information generation unit 410. The free space information generation unit 430 generates free space information in the voxel expression on the basis of the map data (obstacle information) in the voxel expression, and supplies the free space information to the action plan determination unit 70.

According to the above configuration, as described with reference to FIG. 14, it is possible to output the free space information in the voxel expression.

Note that an entire system constituting the mobile body 1D may correspond to not three-dimensional data but two-dimensional data. In this case, the map data in the voxel expression is generated as a so-called grid map. Furthermore, in this case, in the hierarchy division processing, a bounding box is set in a two-dimensional coordinate space indicated by the two axes of the x axis and the y axis, and the division direction and the division position are set on the basis of a direction in which a length of the bounding box is the longest among the two axes.

### 8. Configuration Example of Hardware of Computer

The series of processing described above can be executed by hardware or by software. In a case where the series of processing is executed by software, a program included in the software is installed from a program recording medium on a computer incorporated in dedicated hardware, a general-purpose personal computer, or the like.

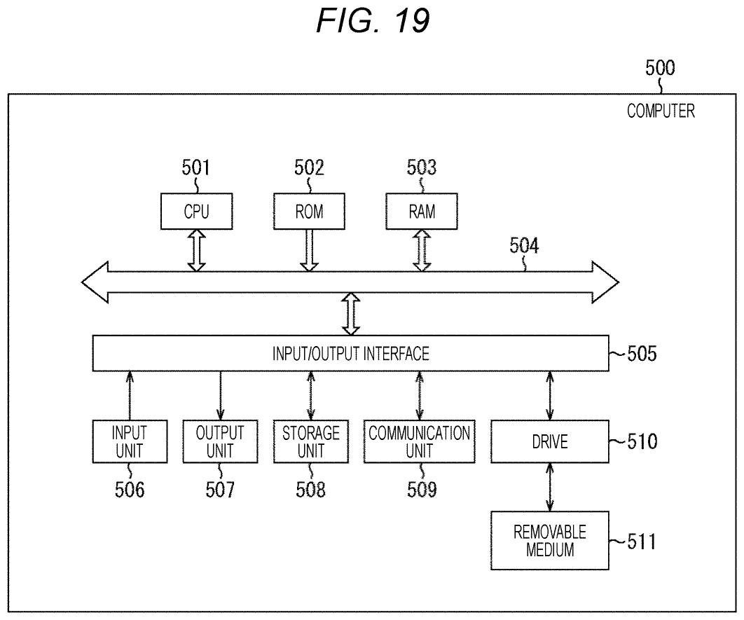

FIG. 19 is a block diagram illustrating a configuration example of hardware of a computer that executes the series of processing described above by a program. A part of the functional blocks constituting the mobile body 1 and the mobile bodies 1A to 1D includes, for example, a PC having a configuration similar to a configuration illustrated in FIG. 19. A central processing unit (CPU) 501, a read only memory (ROM) 502, and a random access memory (RAM) 503 are connected to each other by a bus 504.

An input/output interface 505 is further connected to the bus 504. An input unit 506 including a keyboard, a mouse, and the like, and an output unit 507 including a display, a speaker, and the like are connected to the input/output interface 505. Furthermore, a storage unit 508 including a hard disk, a non-volatile memory, or the like, a communication unit 509 including a network interface or the like, and a drive 510 that drives a removable medium 511 are connected to the input/output interface 505.

In the computer configured as described above, for example, the CPU 501 loads a program stored in the storage unit 508 into the RAM 503 via the input/output interface 505 and the bus 504 and executes the program, whereby the series of processing described above is performed.

For example, the program executed by the CPU 501 is recorded in the removable medium 511, or provided via a wired or wireless transmission medium such as a local area network, the Internet, or digital broadcasting, and then installed in the storage unit 508.

The program executed by the computer may be a program in which the processing is performed in time series in the order described in the present specification, or may be a program in which the processing is performed in parallel or at a necessary timing such as when a call is made.

Note that, in the present specification, the system means a set of a plurality of components (devices, modules (parts), and the like), and it does not matter whether or not all the components are located in the same housing. Therefore, a plurality of devices housed in separate housings and connected to each other via a network and one device in which a plurality of modules is housed in one housing are both the systems.

The effects described in the present specification are merely examples and are not limited, and other effects may be provided.

The embodiment of the present disclosure is not limited to the embodiment described above, and various modifications can be made without departing from the gist of the present disclosure.

For example, the embodiment of the present disclosure can have a configuration of cloud computing in which one function is shared by a plurality of devices via a network and processing is performed in cooperation.

Furthermore, each step described in the flowchart described above can be executed by one device or can be shared and executed by a plurality of devices.

Moreover, in a case where a plurality of pieces of processing is included in one step, the plurality of pieces of processing included in the one step can be executed by one device or can be shared and executed by a plurality of devices.

The effects described in the present specification are merely examples and are not limited, and other effects may be provided.

Moreover, the technology according to the present disclosure can have the following configurations.

(1)

An information processing method including:
setting a plurality of free space line segments between a self-position of a mobile body and obstacle information around the mobile body obtained on the basis of sensor data;
performing, in a case where a line segment group including the free space line segments satisfies a predetermined division condition, division of the line segment group until the division condition is no longer satisfied; and
outputting a set of clusters in which the line segment group obtained by the division is set as one cluster as free space information.

(2)

The information processing method according to (1), in which
out-of-region line segments are further set for a region not included in a field of view from the mobile body in a bounding box surrounding the free space line segments, and
in a case where the line segment group including the free space line segments and the out-of-region line segments satisfies the division condition, the division of the line segment group is performed until the division condition is no longer satisfied.

(3)

The information processing method according to (2), in which
the out-of-region line segments are set on a boundary surface of the field of view from the mobile body and extension lines of the free space line segments that have not reached the bounding box.

(4)

The information processing method according to (3), in which
it is determined whether or not the line segment groups obtained by the division satisfy the division condition by newly setting the bounding boxes for the line segment groups obtained by the division.

(5)

The information processing method according to (4), in which
the division condition includes one or more of a condition for the number of free space line segments included in the bounding box, a condition for presence or absence of the out-of-region line segment in the bounding box, and a condition for a size of the bounding box.

(6)

The information processing method according to (5), in which,
in a case where the number of free space line segments included in the bounding box is a predetermined number or more, division of the line segment group for which the bounding box is set is performed.

(7)

The information processing method according to (6), in which,
in a case where the number of free space line segments included in the bounding box does not exceed the predetermined number, the line segment group for which the bounding box is set is rejected.

(8)

The information processing method according to any one of (5) to (7), in which,
in a case where the out-of-region line segment exists in the bounding box, division of the line segment group for which the bounding box is set is performed.

(9)

The information processing method according to (8), in which,
in a case where the out-of-region line segment does not exist in the bounding box, the line segment group for which the bounding box is set is output.

(10)

The information processing method according to (8) or (9), in which,
in a case where a maximum length of the bounding box exceeds a predetermined value, division of the line segment group for which the bounding box is set is performed.

(11)

The information processing method according to any one of (8) to (10), in which,
in a case where a maximum length of the bounding box does not exceed a predetermined value, the out-of-region line segment included in the line segment group for which the bounding box is set is deleted and output.

(12)

The information processing method according to any one of (4) to (11), in which
the bounding box is set in a coordinate space indicated by a plurality of coordinate axes, and
a division direction and a division position are set on the basis of an axial direction in which a length of the bounding box is longest among axial directions of the plurality of coordinate axes, and the line segment group is divided at the division position.

(13)

The information processing method according to (12), in which
a center position of the bounding box in the division direction is set as the division position.

(14)

The information processing method according to any one of (1) to (13), in which
an output format of the set of clusters including the line segment groups output as the free space information is converted into another output format, and the set of clusters is output.

(15)

The information processing method according to (14), in which
the another output format includes ellipsoid expression based on an average and covariance of the line segment groups included in the clusters.

(16)

The information processing method according to (14), in which
the another output format includes voxel expression in which the clusters are divided in units of voxels.

(17)

The information processing method according to any one of (1) to (16), in which
map data representing a free space in which the mobile body is movable is generated on the basis of the output free space information.

(18)

The information processing method according to any one of (1) to (17), in which
the obstacle information is generated on the basis of point cloud data generated on the basis of the sensor data acquired by a depth sensor.

(19)

An information processing device including:
a setting unit that sets a plurality of free space line segments between a self-position of a mobile body and obstacle information around the mobile body obtained on the basis of sensor data;
a division processing unit that performs, in a case where a line segment group including the free space line segments satisfies a predetermined division condition, division of the line segment group until the division condition is no longer satisfied; and
an output unit that outputs a set of clusters in which the line segment group obtained by the division is set as one cluster as free space information.

(20)

A program for causing a computer to execute processing including:
setting a plurality of free space line segments between a self-position of a mobile body and obstacle information around the mobile body obtained on the basis of sensor data;
performing, in a case where a line segment group including the free space line segments satisfies a predetermined division condition, division of the line segment group until the division condition is no longer satisfied; and
outputting a set of clusters in which the line segment group obtained by the division is set as one cluster as free space information.

### REFERENCE SIGNS LIST

1 Mobile body
10 Depth sensor
20 Point cloud data generation unit
30 Obstacle information generation unit
40 Obstacle map accumulation unit
50 Self-position estimation unit
60 Free space information generation unit
70 Action plan determination unit
80 Actuator control unit
111 Line segment setting unit
112 Division determination unit
113 Division processing unit
114 Output unit
121 Free space line segment setting unit
122 Out-of-region line segment setting unit
210 Free space map accumulation unit
310 Depth sensor
320 Point cloud data generation unit
330 Obstacle information generation unit

1. An information processing method comprising:
setting a plurality of free space line segments between a self-position of a mobile body and obstacle information around the mobile body obtained on a basis of sensor data;
performing, in a case where a line segment group including the free space line segments satisfies a predetermined division condition, division of the line segment group until the division condition is no longer satisfied; and
outputting a set of clusters in which the line segment group obtained by the division is set as one cluster as free space information.

2. The information processing method according to claim 1, wherein
out-of-region line segments are further set for a region not included in a field of view from the mobile body in a bounding box surrounding the free space line segments, and
in a case where the line segment group including the free space line segments and the out-of-region line segments satisfies the division condition, the division of the line segment group is performed until the division condition is no longer satisfied.

3. The information processing method according to claim 2, wherein
the out-of-region line segments are set on a boundary surface of the field of view from the mobile body and extension lines of the free space line segments that have not reached the bounding box.

4. The information processing method according to claim 3, wherein
it is determined whether or not the line segment groups obtained by the division satisfy the division condition by newly setting the bounding boxes for the line segment groups obtained by the division.

5. The information processing method according to claim 4, wherein
the division condition includes one or more of a condition for the number of free space line segments included in the bounding box, a condition for presence or absence of the out-of-region line segment in the bounding box, and a condition for a size of the bounding box.

6. The information processing method according to claim 5, wherein,
in a case where the number of free space line segments included in the bounding box is a predetermined number or more, division of the line segment group for which the bounding box is set is performed.

7. The information processing method according to claim 6, wherein,
in a case where the number of free space line segments included in the bounding box does not exceed the predetermined number, the line segment group for which the bounding box is set is rejected.

8. The information processing method according to claim 5, wherein,
in a case where the out-of-region line segment exists in the bounding box, division of the line segment group for which the bounding box is set is performed.

9. The information processing method according to claim 8, wherein,
in a case where the out-of-region line segment does not exist in the bounding box, the line segment group for which the bounding box is set is output.

10. The information processing method according to claim 8, wherein,
in a case where a maximum length of the bounding box exceeds a predetermined value, division of the line segment group for which the bounding box is set is performed.

11. The information processing method according to claim 8, wherein,
in a case where a maximum length of the bounding box does not exceed a predetermined value, the out-of-region line segment included in the line segment group for which the bounding box is set is deleted and output.

12. The information processing method according to claim 4, wherein
the bounding box is set in a coordinate space indicated by a plurality of coordinate axes, and
a division direction and a division position are set on a basis of an axial direction in which a length of the bounding box is longest among axial directions of the plurality of coordinate axes, and the line segment group is divided at the division position.

13. The information processing method according to claim 12, wherein
a center position of the bounding box in the division direction is set as the division position.

14. The information processing method according to claim 1, wherein
an output format of the set of clusters including the line segment groups output as the free space information is converted into another output format, and the set of clusters is output.

15. The information processing method according to claim 14, wherein
the another output format includes ellipsoid expression based on an average and covariance of the line segment groups included in the clusters.

16. The information processing method according to claim 14, wherein
the another output format includes voxel expression in which the clusters are divided in units of voxels.

17. The information processing method according to claim 1, wherein
map data representing a free space in which the mobile body is movable is generated on a basis of the output free space information.

18. The information processing method according to claim 1, wherein
the obstacle information is generated on a basis of point cloud data generated on a basis of the sensor data acquired by a depth sensor.

19. An information processing device comprising:
a setting unit that sets a plurality of free space line segments between a self-position of a mobile body and obstacle information around the mobile body obtained on a basis of sensor data;
a division processing unit that performs, in a case where a line segment group including the free space line segments satisfies a predetermined division condition, division of the line segment group until the division condition is no longer satisfied; and
an output unit that outputs a set of clusters in which the line segment group obtained by the division is set as one cluster as free space information.

20. A program for causing a computer to execute processing comprising:
setting a plurality of free space line segments between a self-position of a mobile body and obstacle information around the mobile body obtained on a basis of sensor data;
performing, in a case where a line segment group including the free space line segments satisfies a predetermined division condition, division of the line segment group until the division condition is no longer satisfied; and
outputting a set of clusters in which the line segment group obtained by the division is set as one cluster as free space information.
